(19) United States
(12) Patent Application Publication
(10) Pub. No.: US 2017/0211021 A1
(43) Pub. Date: Jul. 27, 2017

(54) MULTI-PURPOSE CLEANING COMPOSITIONS, METHODS OF USING MULTI-PURPOSE CLEANING COMPOSITIONS, AND METHODS FOR MANUFACTURING MULTI-PURPOSE CLEANING COMPOSITIONS

(71) Applicant: THE DIAL CORPORATION, Scottsdale, AZ (US)

(72) Inventors: LELAND M. DANZER, CHANDLER, AZ (US); JEFFREY BANKERS, PHOENIX, AZ (US); PAMELA LAM, SCOTTSDALE, AZ (US)

(73) Assignee: THE DIAL CORPORATION, Scottsdale, AZ (US)

(21) Appl. No.: 15/002,817

(22) Filed: Jan. 21, 2016

(51) Int. Cl. C11D 3/14; C11D 1/66; C11D 1/22

(52) U.S. Cl. CPC C11D 3/14; C11D 1/22; C11D 1/66

(57) ABSTRACT

Multi-purpose cleaning compositions, hard surface cleaning products, methods of using a multi-purpose cleaning composition, and methods for manufacturing multi-purpose cleaning compositions are provided. In an embodiment, a multi-purpose cleaning composition includes water, a surfactant, and borax. The borax is suitable as a water softener for use in pretreating fabric before laundering. Further, the borax is suitable as abrasive particles for use in cleaning a hard surface.

### TECHNICAL FIELD

The technical field generally relates to cleaning compositions, and more particularly relates to cleaning compositions that may be used for multiple purposes such as washing fabric in an automatic laundry washer, pretreating fabric before washing, and cleaning hard surfaces such as tiles, porcelain, countertops, and appliance surfaces.

### BACKGROUND

Hard surface cleaning compositions are commercially important products and enjoy a wide field of use. Typically, hard surface cleaning compositions assist in the removal of dirt and grime from hard surfaces via scrubbing or scouring. Hard surfaces include those which are frequently encountered in lavatories, for example lavatory fixtures such as toilets, shower stalls, bathtubs, and sinks, as well as countertops, walls, and floors. Types of commonly encountered stains on hard surfaces include hard water stains such as lime scale deposits, soap scum stains as well as rust stains. Such hard surfaces and stains may also be found in environments such as kitchens, hospitals, and other locations. Hard water stains are mineral stains caused by the deposition of salts, such as calcium or magnesium salts which are frequently present in hard water which is commonly encountered. Soap scum stains are residues of fatty acid soaps, such as soaps which are based on alkaline salts of low fatty acids. These fatty acids are known to precipitate in hard water due to the presence of metal salts therein, leaving an undesirable residue upon such surfaces. Stains typically referred to as “greasy stains” are surface residues that generally comprise hydrophobic materials often with further materials that leave unsightly residues on surfaces. Rust stains are typically formed by the presence of undesired amounts of iron oxides in water, which may form unsightly deposits on hard surfaces.

Laundry pre-treatment or spotting agents are popular products used to facilitate the removal of stains from fabrics. Typically, pre-treatment agents are applied five minutes or more prior to a laundering procedure so as to facilitate the removal of stains and soil from selected pre-treated areas of the fabric.

A laundry pre-treatment composition will typically include surfactants, laundry enzymes, and a carrier material so as to provide a solid medium that can be applied conveniently to a fabric as an aid in laundering. The composition may include a chemical agent for regulating and for selectively, independently modifying physical and chemical parameters of the product to enhance its functional features and its effectiveness in use. Compositions finding utility as laundry pre-treatment preparations have long been utilized in the laundering and cleaning field. Such preparations have been applied to particular, selected stained or excessively soiled areas of clothing and other fabrics prior to subjecting the pre-treated material to a laundering operation. It has been established that effective pre-treatment of the type described increases the likelihood of removing the soils and stains effectively.

Laundry detergent is a substance that can be added to wash water in an automatic washing machine when washing fabric to help clean the fabric. Laundry detergent has traditionally been a powdered or granular solid, but the use of liquid laundry detergents has gradually increased over the years. Typically, laundry detergent may include surfactants, water softeners, anti re-deposition agents, corrosion inhibitors, fluorescent whitening agents, processing aids, colorants, fragrances, opacifiers, oxygen bleach, enzymes, fabric softening agents, chlorine scavengers, dye transfer inhibitors, malodor control agents, and suds control agents. A surfactant is a substance which, when added to water, significantly reduces the surface tension of the water, allowing the water to penetrate the fabric rather than slide off its surface. The result is that the water can function more effectively, acting to loosen the dirt from the clothing, and then hold the dirt until it can be washed away. A water softener or builder is an agent that sequesters calcium ions from the water molecules by complexation or precipitation. Typical builders are sodium carbonate, complexation agents, soap, and zeolites.

While various compositions are sold for use as a hard surface cleaner, as a laundry pre-treatment product, or as a laundry detergent, there is a desire for the complementary use of a product for different purposes. Accordingly, it is desirable to provide a cleaning composition that may be used for multiple purposes, for example, as a detergent for washing laundry in an automatic laundry washing machine, as a pre-treatment product for application to a fabric before laundering, and as a hard surface cleaner for the abrasive cleaning of hard surfaces. Furthermore, other desirable features and characteristics will become apparent from the subsequent detailed description and the appended claims, taken in conjunction with the accompanying drawings and this background.

### BRIEF SUMMARY

Multi-purpose cleaning compositions, hard surface cleaning products, and methods for manufacturing multi-purpose cleaning compositions are provided. In an embodiment, a multi-purpose cleaning composition includes water, a surfactant, and abrasive borax particles. The abrasive borax particles are suitable as a water softener for use in pretreating fabric before laundering. Further, the abrasive borax particles are suitable for use in cleaning a hard surface.

In another exemplary embodiment, a hard surface cleaning product is provided. The hard surface cleaning product includes a cream composition. The cream composition includes water, a surfactant, and abrasive borax particles. The hard surface cleaning product further includes a packaging container in which the cream composition is stored before use to clean a hard surface.

Another exemplary embodiment provides a method of using a multi-purpose cleaning composition comprising water, a surfactant, dissolved borax and abrasive borax particles. The method includes pretreating fabric with the multi-purpose cleaning composition, wherein the dissolved borax is effective as a water softener. Further, the method includes rubbing the multi-purpose cleaning composition on a hard surface, wherein the abrasive borax particles are effective to remove dirt from the hard surface.

In yet another exemplary embodiment, a method for manufacturing a multi-purpose cleaning composition is provided. The method includes preparing a salt water pre-mix. Also, the method includes mixing a surfactant with water to form a mixture, and blending abrasive borax particles with the mixture. The method further includes mixing the salt water pre-mix with the mixture to form the multi-purpose cleaning composition. In the multi-purpose cleaning composition, the abrasive borax particles remain in particle form suitable for use as abrasive for surface cleaning. Also, the method includes packaging the multi-purpose cleaning composition in a container.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The various embodiments will hereinafter be described in conjunction with the following drawing figures, wherein like numerals denote like elements, and wherein:

FIG. 1 is a schematic illustrating an exemplary method for manufacturing a multi-purpose cleaning composition in accordance with an embodiment; and

FIG. 2 is a perspective view of a multi-purpose cleaning product including the composition of FIG. 1 in accordance with another embodiment.

### DETAILED DESCRIPTION

The following detailed description is merely exemplary in nature and is not intended to limit the multi-purpose cleaning compositions, hard surface cleaning products, and methods for manufacturing multi-purpose cleaning compositions. Furthermore, there is no intention to be bound by any expressed or implied theory presented in the preceding technical field, background or brief summary, or in the following detailed description.

In accordance with the various embodiments herein, borax is provided in compositions and products for use in different manners depending on application. As used herein, borax refers to these closely related minerals or chemical compounds that differ in their crystal water content: anhydrous borax: sodium tetraborate (Na₂B₄O₇); borax pentahydrate (Na₂B₄O₇.5H₂O); and borax decahydrate (Na₂B₄O₇.10H₂O), and also includes the borates formed by the borax during use.

When combined with wash water in an automatic washing machine, the borax may provide water softening or building action. There is frequently a need to reduce calcium and other metals such as magnesium in wash water to improve water hardness and allow detergents to function well. The three most important ways of doing this are: the formation of soluble complexes of the metal ion; the formation of insoluble complexes of the metal ion; and ion-exchange of the metal ion. Detergent components that perform these types of functions and soften the water are called builders. Borax acts as a sequestrant builder, forming soluble complexes with the metal ion and thus removing its unwanted effect. The formation of soluble complexes is a desirable way to achieve a builder effect. The chemical equation for water softening by borax is:

Ca²⁺_{(aq)}Na₂B₄O_{7(aq)}→CaB₄O₇₍ₛ₎↓+2Na⁺_{(aq)}

Mg²⁺_{(aq)}+Na₂B₄O_{7(aq)}→MgB₄O₇₍ₛ₎↓+2Na⁺_{(aq)}

The sodium ions introduced by the borax do not make water ‘hard’. This method is suitable for removing both temporary and permanent types of hardness.

Further, when combined with wash water in an automatic washing machine, the borax may provide alkaline buffering and pH control of washing solution. High alkalinity in the wash water improves detergency and helps with the cleaning process. Negative electrostatic charges on the fabric and soil are created in such systems. These negative charges repel each other and help to remove the soil from the fabric. Alkalinity helps to remove fatty soils through saponification. Borax is an excellent pH buffer in the range of pH of from about 9 to about 10, such as from about 9.1 to about 9.3.

Also, in the wash water, the borax may improve surfactant performance by minimizing precipitation of a calcium/surfactant complex. To improve surfactant performance, positively charged calcium ions associated with wash waters and certain soils are desirably prevented from complexing with the negatively charged surfactants used in detergent formulations, since the resultant complexes are insoluble. Should this reaction take place, some of the surfactant is effectively removed from the wash and unable to perform its function. Borax minimizes the precipitation of important types of negatively charged surfactants and may prevent such precipitation (unless exceptionally high levels of calcium are present in the wash). Borax provides successful competition with the surfactant for the metal ions, such as calcium ions or magnesium ions, and forms soluble complexes, thus enhancing the water softening qualities of the detergent as discussed above.

When provided in the wash water, the borax may remove pigment and/or soil from fabric and minimize re-deposition. Alkaline detergent liquors help remove and emulsify fatty soils. As pH rises in the wash liquor, the interfacial tension (between the liquor and fatty soils) falls dramatically. This is caused by the saponification of the fatty soils. Likewise, alkalinity promotes the formation of negative charges both on particulate soils and fabrics. By repelling each other, these charges assist in soil removal and help prevent re-deposition. Borax causes a greater reduction in the interfacial tensions than is simply due to pH, thus improving oily soil detergency. Further, particulate soil deposition is inhibited by borax through its specific influence on surface charge beyond the pH effect.

Borax also provides stabilization for enzymes in liquid laundry detergent. Likewise, borax may provide stabilization for enzymes in laundry pre-treatment products. Further, while during pre-treatment use borax is not combined with wash water, borax may provide improved surfactant performance when the fabric treated with the borax is introduced into the wash water.

In use as a hard surface cleaner, the borax is utilized in its solid particulate form as an abrasive. Borax particles have a particle size as measured by sieve diameter. A sieve diameter is defined as the width of the minimum square aperture through which the particle will pass. Typically, particles within a batch will have a distribution of particle sizes. Exemplary borax particles are those in which a majority of particles have a sieve diameter of at least 0.04 mm, such as at least about 0.05 mm, for example at least about 0.06 mm. In an exemplary embodiment, a majority of the particles have a sieve diameter of at least 0.07 mm, or at least about 0.08 mm. In another exemplary embodiment, a majority of the particles have a sieve diameter of at least 0.09 mm, or at least about 0.10 mm. Exemplary borax particles used herein have a particle size distribution such that no more than about 0.1% of the borax particles have a sieve diameter of at least 2.38 mm, no more than about 35% of the borax particles have a sieve diameter of at least 0.595 mm, and at least about 75% of the borax particles have a sieve diameter of at least 0.074 mm.

Exemplary abrasive borax particles used herein have a Mohs hardness of about 2 to about 3, i.e., from gypsum (2) to calcite (3). An exemplary cleaning composition employing an abrasive comprising borax provides superior soap scum and bathroom soil removal and good surface safety. “Surface safety” refers to a property of acceptable and minimal damage to a glossy or shiny hard surface as measured by reduction of gloss versus an uncleaned hard surface.

In embodiments, the aforementioned composition has multiple applications and is also employed as a hard surface cleaner. As a hard surface cleaner, the composition is provided with abrasive consisting essentially of borax. Although borax is readily soluble in water, the amount of borax employed in the cleaning composition is typically greater than can be solubilized in the amount of water included in the cleaning composition or in the total amount of water included in the cleaning composition and used in conjunction with the cleaning composition. Therefore, a portion of the borax remains undissolved and suspended during surface cleaning. This suspension of borax acts as an abrasive for enhanced cleaning performance, especially for cleaning of stubbornly adhering soils on smooth or glossy hard surfaces. Borax has a solubility in water of about 38.1 g/L at 20° C., a solubility in glycerol or about 1 g/L at room temperature, is slightly soluble in ethanol and is insoluble in acids. A saturated aqueous solution of borax will comprise about 3.79 weight percent (wt. %) borax at 15° C., about 4.71 wt. % borax at 20° C., about 5.80 wt. % borax at 25° C., and about 7.20 wt. % borax at 30° C.

Therefore, a single cleaning composition including borax is provided for use as a laundry detergent, fabric pre-treatment product, and hard surface cleaner in accordance with the various embodiments herein. An exemplary multiple purpose cleaning composition includes from about 10 wt. % to about 60 wt. % borax, by total weight of the multi-purpose cleaning composition. In another embodiment, the multiple purpose cleaning composition includes from about 30 wt. % to about 50 wt. % borax, by total weight of the multi-purpose cleaning composition. For example, an exemplary multiple purpose cleaning composition includes from about 35 wt. % to about 45 wt. % borax, such as about 40 wt. % borax, by total weight of the multi-purpose cleaning composition.

In addition to the borax, an exemplary multiple purpose cleaning composition includes a surfactant or surfactants. Suitable surfactants may include ionic surfactants, anionic surfactants, cationic surfactants, and/or non-ionic surfactants. An exemplary embodiment utilizes an anionic surfactant in combination with a non-ionic surfactant. In an exemplary embodiment, the multiple purpose cleaning composition includes from about 3 wt. % to about 20 wt. % surfactant, by total weight of the multi-purpose cleaning composition. An exemplary multiple purpose cleaning composition includes from about 5 wt. % to about 15 wt. % surfactant, by total weight of the multi-purpose cleaning composition. For example, a multiple purpose cleaning composition may include from about 6 wt. % to about 13 wt. % surfactant, such as about 8.8 wt. % surfactant, by total weight of the multi-purpose cleaning composition.

An exemplary anionic surfactant is linear alkylbenzene sulfonic acid (HLAS). As used herein, “HLAS surfactant” refers to alkyl benzene sulfonic acids and alkali metal salts of C₁₀-C₁₆ alkyl benzene sulfonic acids, such as C₁₁-C₁₄ alkyl benzene sulfonic acids. The alkali group can be linear and such linear alkyl benzene sulfonates are known as “LAS”. Alternatively the alkali group can be branched and may be known as branched alkyl benzene sulfonic acids. An example of an HLAS surfactant is sodium linear alkyl benzene sulfonate, commonly referenced as “NaLAS.” In an exemplary embodiment, the multiple purpose cleaning composition includes from about 2 wt. % to about 12 wt. % anionic surfactant, by total weight of the multi-purpose cleaning composition. An exemplary multiple purpose cleaning composition includes from about 4 wt. % to about 10 wt. % anionic surfactant, by total weight of the multi-purpose cleaning composition. For example, a multiple purpose cleaning composition may include from about 5 wt. % to about 7 wt. % anionic surfactant, such as about 6.8 wt. % anionic surfactant, by total weight of the multi-purpose cleaning composition.

An exemplary non-ionic surfactant includes ethoxylated and/or propoxylated primary alcohols having alcohol chain lengths of 8 to 18 carbon atoms and on average from 2 to 0.5 moles of ethylene oxide (EO) and/or from 0.5 to 10 moles of propylene oxide (PO) per mole of alcohol. An exemplary embodiment includes alcohol ethoxylates containing linear radicals from alcohols of natural origin having 8 to 18 carbon atoms ethoxylated with an average of from 4 to about 12 moles EO per mole of alcohol. A commercially available nonionic alcohol ethoxylate surfactant that may find use herein includes without limitation C₁₀-C₁₂ alcohol ethoxylate-8EO (available as Surfonic® L12-8 from Huntsman Corporation and as HSC-800 NRE® from Huntsman Corporation). In an exemplary embodiment, the multiple purpose cleaning composition includes from about 0.5 wt. % to about 5 wt. % non-ionic surfactant, by total weight of the multi-purpose cleaning composition. An exemplary multiple purpose cleaning composition includes from about 1 wt. % to about 3 wt. % non-ionic surfactant, by total weight of the multi-purpose cleaning composition. For example, a multiple purpose cleaning composition may include from about 1.5 wt. % to about 2.5 wt. % non-ionic surfactant, such as about 1.9 wt. % non-ionic surfactant, by total weight of the multi-purpose cleaning composition.

In addition to the borax and the surfactant(s), an exemplary multiple purpose cleaning composition includes de-ionized water. In an exemplary embodiment, the multiple purpose cleaning composition includes from about 30 to about 60 wt. % water, by total weight of the multi-purpose cleaning composition. An exemplary multiple purpose cleaning composition includes from about 40 to about 55 wt. % water, by total weight of the multi-purpose cleaning composition. For example, a multiple purpose cleaning composition may include from about 45 wt. % to about 50 wt. % water, such as about 47 wt. % water, by total weight of the multi-purpose cleaning composition

Exemplary embodiments of multiple purpose cleaning compositions may optionally include one or more one or more further constituents useful in improving one or more aesthetic characteristics of the compositions or in improving one or more technical characteristics of the compositions. Exemplary further optional constituents include pH adjusting agents and pH buffers, fillers, coloring agents, perfume or fragrances and fragrance solubilizers, viscosity modifying agents including one or more thickeners, optical brighteners, opacifying agents, hydrotropes, and preservatives, as well as other optional constituents providing improved technical or aesthetic characteristics known to the relevant art.

In an exemplary embodiment, the multiple purpose cleaning composition includes alkaline materials, such as sodium hydroxide and/or sodium bicarbonate, as pH adjusting agents. Although the multiple purpose cleaning composition includes borax, which increases pH, it may be desirable to add separate alkaline and/or acidic materials that are more readily soluble in water in order to adjust (and buffer) the composition to a desired final alkaline pH. In addition or as an alternative to sodium hydroxide and sodium bicarbonate, materials useful to increase the pH of the compositions may include any alkali metal or alkaline earth hydroxide, any ammonia/ammonium hydroxide, any alkylamine (primary, secondary or tertiary amine), or any alkanolamine (monoethanolamine, diethanolamine, or triethanolamine, for example). Besides these, other alkaline materials may be used including soluble carbonates, sesquicarbonates, bicarbonates, citrates, silicates, and such, provided that such materials are compatible with the other components of the multiple purpose cleaning composition.

In an exemplary embodiment, the multiple purpose cleaning composition includes from about 0.5 wt. % to about 5 wt. % pH adjusting agent, by total weight of the multi-purpose cleaning composition. An exemplary multiple purpose cleaning composition includes from about 1 wt. % to about 2.5 wt. % pH adjusting agent, such as about 2 wt. % pH adjusting agent, by total weight of the multi-purpose cleaning composition. In an exemplary embodiment, the multiple purpose cleaning composition includes from about 0.5 wt. % to about 1.5 wt. % sodium hydroxide, by total weight of the multi-purpose cleaning composition. An exemplary multiple purpose cleaning composition includes from about 0.8 wt. % to about 1.2 wt. % sodium hydroxide, such as about 1 wt. % sodium hydroxide, by total weight of the multi-purpose cleaning composition. In an exemplary embodiment, the multiple purpose cleaning composition includes from about 0.05 wt. % to about 0.3 wt. % sodium bicarbonate, by total weight of the multi-purpose cleaning composition. An exemplary multiple purpose cleaning composition includes from about 0.1 wt. % to about 0.2 wt. % sodium bicarbonate, such as about 0.125 wt. % sodium bicarbonate, by total weight of the multi-purpose cleaning composition.

In an exemplary embodiment, the multiple purpose cleaning composition includes a filler or fillers. The filler may be used to lower the cost of the multiple purpose cleaning composition and to maintain desired physical properties such as viscosity, solubility, consistency or phase. The filler may improve evenness of dispersion. In an exemplary embodiment, the filler is a salt, such as sodium chloride, to increase viscosity and to improve detergency. In an exemplary embodiment, the multiple purpose cleaning composition includes from about 0.5 wt. % to about 2 wt. % filler, by total weight of the multi-purpose cleaning composition. An exemplary multiple purpose cleaning composition includes from about 1 wt. % to about 2 wt. % filler, such as about 1.3 wt. % filler, by total weight of the multi-purpose cleaning composition.

In an exemplary embodiment, the multiple purpose cleaning composition includes a microbiocidally active compound or compounds as a preservative. For example, the multiple purpose cleaning composition may include MIT (2-methyl-2H-isothiazol-3-one) and/or BIT (1,2-benzisothiazolin-3-one). In an exemplary embodiment, the multiple purpose cleaning composition includes from about 0.001 wt. % to about 0.01 wt. % active preservative, by total weight of the multi-purpose cleaning composition. An exemplary multiple purpose cleaning composition includes about 0.005 wt. % active preservative, by total weight of the multi-purpose cleaning composition.

In an exemplary embodiment, the multiple purpose cleaning composition is formed as a cream. An exemplary cream is flowable under pressure. In an exemplary embodiment, the multi-purpose cleaning composition has a viscosity of from about 2500 to about 15000 millipascal second (mPa s), such as from about 5000 to about 12000 mPa s, for example, from about 8000 to about 10000 mPa s. In an exemplary embodiment, the multi-purpose cleaning composition has a specific gravity of from about 1.2 to about 1.5, such as from about 1.25 to about 1.42. In an exemplary embodiment, the multi-purpose cleaning composition has a pH of from about 9.5 to about 14.0, such as from about 10.5 to about 12.0, or about 11.

Table A provides an exemplary multiple purpose cleaning composition.

TABLE A
Multi-purpose cleaning composition

| | | Wt. %, | Wt. % | |
|---|---|---|---|---|
| | Ingredient | Active | of | Weight |
| | wt. % | Basis | Total | (grams) |
| 23% Salt water solution | 23 | 1.300 | 5.652 | 197.820 |
| Deionized Water | 0 | 0.000 | 43.113 | 1508.955 |
| NaOH (50% solution) | 50 | 0.980 | 1.960 | 68.600 |
| NaHCO₃ | 100 | 0.125 | 0.125 | 4.375 |
| HLAS | 100 | 6.840 | 6.840 | 239.400 |
| Borax (10 mol) | 100 | 40.000 | 40.000 | 1400.000 |
| HSC-800 NRE ® | 90 | 1.764 | 1.960 | 68.600 |
| Perfume Lemon | 100 | 0.25 | 0.250 | 8.750 |
| Acticide ® MBS | 5 | 0.005 | 0.100 | 3.500 |
| TOTAL | | 51.264 | 100.000 | 3500.000 |

The Borax (10 mol) listed in Table A is commercially available as 20 Mule Team® Borax from the Dial Corporation, as 99% sodium tetraborate (Na₂B₄O₇).10H₂O and 1% water. The salt water solution is 23% sodium chloride. HSC-800 NRE® is a C₁₀-C₁₂ alcohol ethoxylate-8EO available from Huntsman Corporation. Acticide® MBS is a water borne formulation of MIT/BIT commercially available from Thor Specialties.

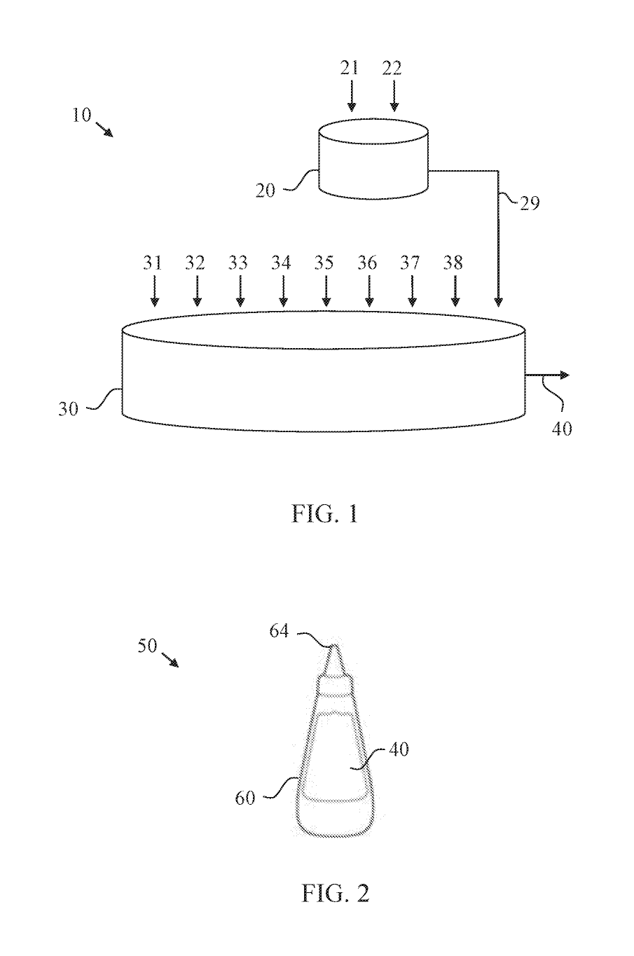

FIG. 1 illustrates a method 10 for manufacturing a multi-purpose cleaning composition in accordance with an embodiment herein. As shown, a pre-mix tank 20 is provided and receives deionized water 21 and a salt filler 22, such as sodium chloride. In an exemplary method, the water 21 is first added to the tank 20 and is circulated while the salt filler 22 is added. The water 21 and salt filler 22 form a pre-mix 29 that is a salt solution having a desired salt concentration. For example, the pre-mix 29 may be formed with a salt concentration of from about 10% to about 40%, such as from about 20% to about 30%, such as about 23%. In an exemplary embodiment of Table A, 197.820 grams of pre-mix solution 29 is formed from 152.321 grams of deionized water 21 and 45.499 grams of NaCl.

The method 10 also utilizes a main tank 30. As shown, in exemplary method 10, deionized water 31 is added to the main tank 30. In the embodiment of Table A, 1508.955 grams of deionized water 31 is added to the main tank 30. A pH adjusting agent 32 is then added to the main tank 30. An exemplary pH adjusting agent is a 50% solution of NaOH. In the embodiment of Table A, 68.600 grams of 50% solution of NaOH as pH adjusting agent 32 is added to the main tank 30. Further, a second pH adjusting agent 33 is added to the main tank 30. An exemplary pH adjusting agent is NaHCO₃. In the embodiment of Table A, 4.475 grams of NaHCO₃ as pH adjusting agent 33 is added to the main tank 30. The NaHCO₃ is blended into the water mixture until dissolved.

In FIG. 1, the method continues with the addition of a surfactant 34 to the main tank 30. For example, HLAS may be added as the surfactant 34. In the embodiment of Table A, 239.400 grams of HLAS is added to the tank 30 and is mixed until dissolved. For example, the HLAS may be mixed for about 10 minutes. At this point, the pH of the mixture in the main tank 30 should be from about 11.2 to about 12.2.

As shown, borax 35 is added to the mixture in the main tank 30. The borax may be provided as 5 mol or 10 mol. The borax 35 is mixed for about 15 minutes to provide for sufficient dissolution. In the embodiment of Table A, 1400.000 grams of borax 35 is added to the tank 30.

A surfactant 36 is then added to the mixture in the main tank 30. An exemplary surfactant is Surfonic® L12-8. In the embodiment of Table A, 68.600 grams of surfactant 36 is added to the main tank 30. The surfactant 36 may be heated, such as to a temperature of about 37.78 degrees C. (about 100 degrees F.). Further, after adding the surfactant 36, the mixture may be mixed for about 20 minutes. In FIG. 1, a preservative 37 and perfume 38 are then added to the main tank 30. In the embodiment of Table A, 3.500 grams of preservative 37 and 8.750 grams of perfume 38 are added to the main tank 30.

As shown in FIG. 1, the pre-mix 29 is then added to the main tank 30 and is mixed for about 20 minutes. As a result of the method of FIG. 1, 3500 grams of a multi-purpose cleaning composition 40 is formed. The exemplary multi-purpose cleaning composition 40 has a white cream appearance and a viscosity of from about 5000 to about 12000 mPa s. Further, the exemplary multi-purpose cleaning composition 40 has a specific gravity of from about 1.25 to about 1.42. Also, the exemplary multi-purpose cleaning composition 40 has a pH of from about 10.5 to about 12.0. The method 10 may conclude with packaging the multi-purpose cleaning composition 40 in a container.

FIG. 2 illustrates the multi-purpose cleaning composition 40 provided as a product 50 for use as a laundry detergent, a pre-treatment product, or a hard surface cleaner. As shown, the multi-purpose cleaning composition 40 is housed in a product container 60. An exemplary product container 60 is compressible or squeezable to provide for a reduction in interior volume to force a desired amount of the multi-purpose cleaning composition 40 to exit the container 60. The container 60 may be provided with a nozzle 64 to facilitate ejection of the desired amount of the multi-purpose cleaning composition 40. As the multi-purpose cleaning composition 40 is a viscous cream, the multi-purpose cleaning composition 40 may be selectively ejected from the container 60 without spilling.

During use as a laundry detergent, the multi-purpose cleaning composition 40 may be directed into the wash water, onto the fabric to be laundered, or into a tray of an automated washing machine. During use as a pre-treatment product, the multi-purpose cleaning composition 40 may be directly applied to a stained area of a fabric. During use as a hard surface cleaner, the multi-purpose cleaning composition 40 may be applied directly to the hard surface to be cleaned.

In accordance with the various embodiments herein, an all-inclusive multi-purpose cleaning composition is provided. The multi-purpose cleaning composition includes components sufficient for laundering, for pre-treatment of fabrics before laundering, and for cleaning hard surfaces. Borax is provided as a water softener or builder for laundering purposes and as an abrasive for use in cleaning hard surfaces. The borax is provided as both a dissolved component and as suspended particles within the multi-purpose cleaning composition.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration as claimed in any way. Rather, the foregoing detailed description will provide those skilled in the art with a convenient road map for implementing the exemplary embodiment or exemplary embodiments. It should be understood that various changes can be made in the function and arrangement of elements without departing from the scope herein as set forth in the appended claims and the legal equivalents thereof.

What is claimed is:

1. A multi-purpose cleaning composition comprising:
water;
a surfactant; and
abrasive borax particles, wherein the borax is suitable as a water softener for use in pretreating fabric before laundering and as abrasive particles for use in cleaning a hard surface.

2. The multi-purpose cleaning composition of claim 1 wherein the multi-purpose cleaning composition is comprised of from about 10 wt. % to about 60 wt. % borax, by total weight of the multi-purpose cleaning composition.

3. The multi-purpose cleaning composition of claim 1 wherein the multi-purpose cleaning composition is comprised of from about 30 wt. % to about 50 wt. % borax, by total weight of the multi-purpose cleaning composition.

4. The multi-purpose cleaning composition of claim 1 wherein the multi-purpose cleaning composition has a viscosity of from about 2500 to about 15000 millipascal second (mPa s).

5. The multi-purpose cleaning composition of claim 1 wherein the multi-purpose cleaning composition has a viscosity of from about 5000 to about 12000 millipascal second (mPa s).

6. The multi-purpose cleaning composition of claim 1 wherein the multi-purpose cleaning composition has a specific gravity of from about 1.2 to about 1.5.

7. The multi-purpose cleaning composition of claim 1 wherein the multi-purpose cleaning composition has a specific gravity of from about 1.25 to about 1.42.

8. The multi-purpose cleaning composition of claim 1 wherein the multi-purpose cleaning composition has a pH of from about 9.5 to about 14.0.

9. The multi-purpose cleaning composition of claim 1 wherein the multi-purpose cleaning composition has a pH of from about 10.5 to about 12.0.

10. The multi-purpose cleaning composition of claim 1 wherein the surfactant includes:
linear alkylbenzene sulfonic acid (HLAS); and
a C₁₀-C₁₂ alcohol ethoxylate-8EO.

11. The multi-purpose cleaning composition of claim 10 wherein the multi-purpose cleaning composition comprises from about 5 wt. % to about 10 wt. % HLAS and from about 1 to about 3 wt. % C₁₀-C₁₂ alcohol ethoxylate-8EO.

12. The multi-purpose cleaning composition of claim 1 further comprising:
sodium hydroxide;
sodium bicarbonate;
salt; and
a preservative.

13. The multi-purpose cleaning composition of claim 12 wherein the multi-purpose cleaning composition comprises:
from about 45 to about 55 wt. % water;
from about 6 wt. % to about 13 wt. % surfactant;
from about 30 to about 50 wt. % borax;
from about 0.5 to about 1.5 wt. % sodium hydroxide;
from about 0.08 to about 0.15 wt. % sodium bicarbonate;
from about 1.0 to about 1.5 wt. % salt; and
from about 0.07 to about 0.13 wt. % preservative.

14. The multi-purpose cleaning composition of claim 1 wherein the multi-purpose cleaning composition is packaged in a packaging container in which the multi-purpose cleaning composition is stored before use in pretreating fabric or to clean a hard surface.

15. A method of using a multi-purpose cleaning composition comprising water, a surfactant, dissolved borax and abrasive borax particles, the method comprising:
pretreating fabric with the multi-purpose cleaning composition, wherein the dissolved borax is effective as a water softener; and
rubbing the multi-purpose cleaning composition on a hard surface, wherein the abrasive borax particles are effective to remove dirt from the hard surface.

16. The method of claim 15 wherein the composition is comprised of from about 30 wt. % to about 50 wt. % borax, by total weight of the composition.

17. The method of claim 16 wherein the composition has a viscosity of from about 5000 to about 12000 millipascal second (mPa s) and wherein the composition has a specific gravity of from about 1.25 to about 1.42.

18. The method of claim 17 wherein the composition has a pH of from about 10.5 to about 12.0.

19. The method of claim 18 wherein the composition is comprised of:
from about 45 to about 55 wt. % water;
from about 6 wt. % to about 13 wt. % surfactant; and
from about 30 to about 50 wt. % borax; and wherein the composition further comprises:
from about 0.5 to about 1.5 wt. % sodium hydroxide;
from about 0.08 to about 0.15 wt. % sodium bicarbonate;
from about 1.0 to about 1.5 wt. % salt; and
from about 0.07 to about 0.13 wt. % preservative.

20. A method for manufacturing a multi-purpose cleaning composition, the method comprising:
preparing a salt water pre-mix;
mixing a surfactant with water to form a mixture;
blending borax with the mixture;
mixing the salt water pre-mix with the mixture to form the multi-purpose cleaning composition, wherein the borax remains in particle form suitable for use as abrasive for surface cleaning; and
packaging the multi-purpose cleaning composition in a container.
